(19) United States
(12) Patent Application Publication
(10) Pub. No.: US 2012/0266030 A1
(43) Pub. Date: Oct. 18, 2012

(54) WATCHDOG TIMER TEST SYSTEM AND METHOD

(75) Inventor: MING LI, Shenzhen City (CN)

(73) Assignees: HON HAI PRECISION INDUSTRY CO., LTD., Tu-Chung (TW); HON FU JIN PRECISION INDUSTRY (ShenZhen) CO., LTD., Shenzhen City (CN)

(21) Appl. No.: 13/441,930

(22) Filed: Apr. 9, 2012

(30) Foreign Application Priority Data
Apr. 13, 2011 (CN) 201110092133.2

(51) Int. Cl. G06F 11/28

(52) U.S. Cl. 714/47.1; 714/E11.178

(57) ABSTRACT

A computer and method tests a watchdog timer of a baseboard management controller (BMC) of a motherboard. The computer obtains a count value from the watchdog timer. The computer calculates an accuracy value according to a beginning time of countdown, and a stop time of the countdown. The computer determines if the accuracy value falls within the predetermined qualification range and displays a determination on a display device of the computer.

### BACKGROUND

1. Technical Field

Embodiments of the present disclosure relate to information processing technology, and particularly to a watchdog timer test system and method.

2. Description of Related Art

A baseboard management controller (BMC) is a specialized microcontroller embedded in a motherboard of a computer. The BMC manages interfaces between system management software and platform hardware. The BMC may include a watchdog timer. The watchdog timer is a built-in unit of the BMC that triggers a BMC reset if the BMC has a problem. The watchdog timer brings the BMC back from a unresponsive state into a normal state, which is a very important purpose. However, manual testing of the watchdog timer requires the setting of parameters, and after a test is finished, a user manually resets the watchdog timer to obtain test information (e.g., a beginning time of the test, a stop time of the test). Improved methods of testing the watchdog timer are desirable.

### BRIEF DESCRIPTION OF THE DRAWINGS

FIG. 1 is a system view of one embodiment of a watchdog timer test system.

FIG. 2 is a block diagram of one embodiment of a computer of FIG. 1.

FIG. 3 is a flowchart of one embodiment of a watchdog timer test method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

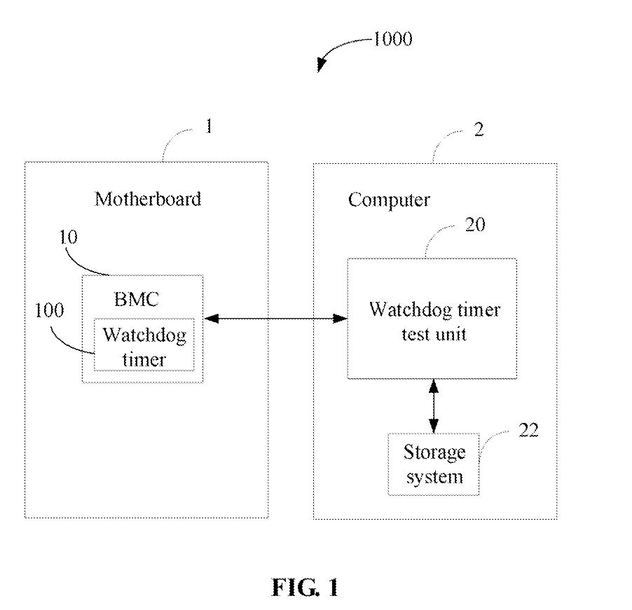

FIG. 1 is a system view of one embodiment of a watchdog timer test system 1000. In one embodiment, the watchdog timer test system 1000 may include a motherboard 1 and a computer 2. The motherboard 1, which includes a baseboard management controller (BMC) 10, is connected to the computer 2 via an interface (e.g., a universal serial bus port). The watchdog timer test system 1000 may be used to test stability of a watchdog timer 100 of the BMC 10.

The computer 2 includes a watchdog timer test unit 20. In one embodiment, the computer 2 may be a personal computer (PC), a network server, or any other data-processing equipment. Further details of the watchdog timer test unit 20 will be described below.

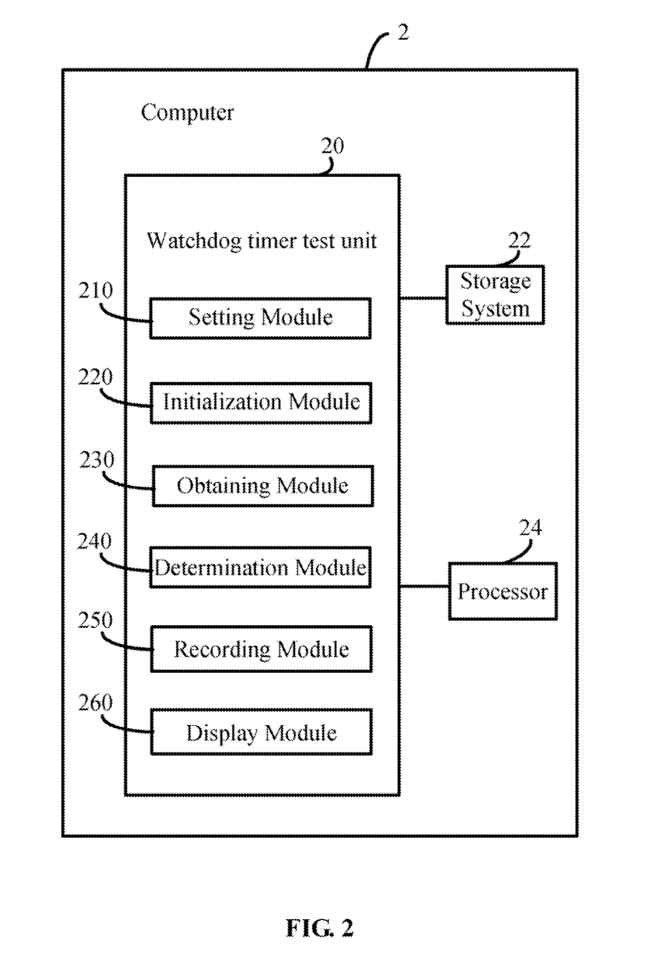

FIG. 2 is a block diagram of one embodiment of the computer 2 of FIG. 1. In one embodiment, the computer 2 includes a storage system 22, and at least one processor 24. In one embodiment, the watchdog timer test unit 20 further includes a setting module 210, an initialization module 220, an obtaining module 230, a determination module 240, a recording module 250, and a display module 260. The modules 210-260 may include computerized code in the form of one or more programs that are stored in the storage system 22. The computerized code includes instructions that are executed by the at least one processor 24 to provide functions for modules 210-260. The storage system 22 may be an EPROM, a flash, or a hard drive.

The setting module 210 sets parameters of a test of the watchdog timer 100 of the BMC 10. In one embodiment, the parameters include a time duration (e.g., 6 minutes) of the watchdog timer 100, and a predetermined qualification range. The predetermined qualification range is used to determine if the watchdog timer 100 is qualified. For example, the predetermined qualification range may be [0, 10%] (a percentage error of a countdown). It is noted that, in this embodiment, the predetermined qualification range between the minimum boundary value and the maximum boundary value are allowable errors.

The initialization module 220 initializes the watchdog timer 100 to convert the time duration into an initialization value. In one embodiment, the initialization module 220 uses an initialization function to convert the time duration into the initialization value. The initialization value is used for the countdown. For example, if the time duration is six minutes, the initialization module 220 converts the six minutes into a number of seconds, or a number of parts of a second (e.g., the number 3600). The watchdog timer 100 counts backward from the initialization value to a specific value (e.g., from 3600 to the number zero).

The obtaining module 230 obtains a count value from the watchdog timer 100. The count value proceeds as the watchdog timer 100 counts backward from the initialization value to zero. The count value may be any value between the initialization value and the specific value.

The determination module 240 determines if the count value is equal to the initialization value. In one embodiment, if the count value is equal to the initialization value, the determination module 240 determines that the watchdog timer 100 has not yet started the countdown. If the count value is not equal to the initialization value, the determination module 240 determines that the watchdog timer 100 has started the countdown. For example, assuming that the count value happens to be at 3599, then the determination module 240 determines that the watchdog timer 100 has started the countdown.

The recording module 250 obtains a beginning time of the countdown when the watchdog timer 100 starts the countdown. For example, if the time happens to be 8:30:20 AM when the watchdog timer 100 starts the countdown, the recording module 250 obtains the 8:30:20 AM into the storage system 22.

The determination module 240 determines if the watchdog timer 100 stops the countdown. In one embodiment, if the count value is equal to the specific value (e.g., zero), then the watchdog timer 100 stops the countdown.

The recording module 250 obtains a stop time of the countdown and calculates an accuracy value. In one embodiment, the accuracy value is calculated as by: A=(T₂−T₁)/N, wherein A is the accuracy value, T₂ is the stop time of the countdown, T₁ is the beginning time of the countdown, and N is the initialization value.

The determination module 240 determines if the accuracy value falls within the predetermined qualification range. For example, if the accuracy value is calculated as 0.1000, the accuracy value falls within the predetermined qualification range which is [0, 10%] (a percentage error of a countdown).

The display module 260 displays test qualified or unqualified information on a display device of the computer 2. In one embodiment, the displaying module 260 displays the test qualified information on the display device, in response to a determination that the accuracy value falls within the predetermined qualification range. For example, if the accuracy value is 0.1000, then the displaying module 260 displays “QUALIFIED” on the display device. The displaying module 260 also displays the test unqualified information on the display device, in response to a determination that the accuracy value falls outside the predetermined qualification range. For example, if the accuracy value is 0.3000, then the displaying module 260 displays “UNQUALIFIED” on the display device.

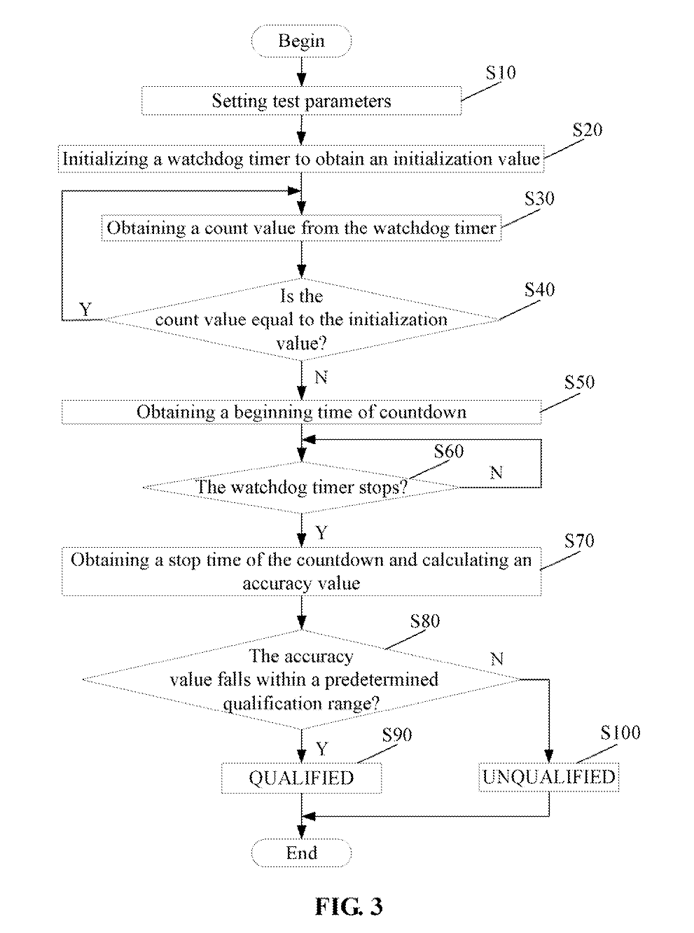

FIG. 3 is a flowchart of one embodiment of a watchdog timer test method. Depending on the embodiment, additional steps may be added, others deleted, and the ordering of the steps may be changed.

In step S10, the setting module 210 sets parameters of a test of the watchdog timer 100 of the BMC 10. As mentioned above, the parameters include a time duration (e.g., 6 minutes) of the watchdog timer 100, a predetermined qualification range of the watchdog timer 100. For example, the predetermined qualification range may be [0, 10%]. The predetermined qualification range is used to determined if the watchdog timer 100 is qualified.

In step S20, the initialization module 220 initializes the watchdog timer 100 to convert the time duration into an initialization value. For example, if the time duration is six minutes, the initialization module 220 converts the six minutes into a number of seconds, or number of parts of a second (e.g., the number 3600).

In step S30, the obtaining module 230 obtains a count value from the watchdog timer 100. For example, the count value may be 3600, 3599, or zero.

In step S40, the determination module 240 determines if the watchdog timer 100 has started countdown by determining if the count value is equal to the initialization value. In one embodiment, if the count value is equal to the initialization value, the determination module 240 determines that the watchdog timer 100 has not yet started the countdown, and the procedure returns to step S30. Otherwise, if the count value is not equal to the initialization value, the determination module 240 determines that the watchdog timer 100 has started the countdown, and the procedure goes to step S50. For example, assuming that the current count value is 3599, then the watchdog timer 100 is determined to have started the countdown, and the procedure goes to step S50.

In step S50, the recording module 250 obtains a beginning time of the countdown when the watchdog timer 100 starts the countdown. For example, if the time is 8:30:20 AM when the watchdog timer 100 starts the countdown, and the recording module 250 obtains the 8:30:20 AM into the storage system 22.

In step S60, the determination module 240 determines if the watchdog timer 100 stops the countdown. In one embodiment, if the count value is equal to the specific value (e.g., zero), the watchdog timer 100 stops the countdown, and the procedure goes to step S70.

In step S70, the recording module 250 obtains a stop time of the countdown and calculates an accuracy value. Using the formula A as mentioned above, the accuracy value is computed. For example, the accuracy value may be calculated as 0.1000.

In step S80, the determination module 240 determines if the accuracy value falls within the predetermined qualification range. For example, if the accuracy value is calculated as 0.1000, then the accuracy value does fall within the predetermined qualification range which is [0, 10%]. For an accuracy value within the predetermined qualification range, the procedure goes to step S90. Otherwise, if the accuracy value is calculated as 0.3000 and outside the predetermined qualification range, the procedure goes to step S100.

In step S90, the display module 260 displays test qualified information on the display device of the computer 2. As mentioned above, the display module 260 displays “QUALIFIED” on the display device of the computer 2 to indicate a satisfactory test.

In step S100, the display module 260 displays test unqualified information on the display device of the computer 2 indicating a test failure. As mentioned above, the display module 260 displays “UNQUALIFIED” on the display device of the computer 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, the computer in electronic communication with a motherboard, the computer comprising:
a storage system;
at least one processor; and
one or more programs stored in the storage system and being executable by the at least one processor, the one or more programs comprising:
a setting module that sets parameters for a test of a watchdog timer of a baseboard management controller (BMC) of the motherboard, wherein the parameters comprise a time duration of the watchdog timer, a predetermined qualification range of the watchdog timer;
an initialization module that initializes the watchdog timer to convert the time duration into an initialization value, wherein the watchdog timer counts backward from the initialization value to zero;
an obtaining module that obtains a count value from the watchdog timer;
a recording module that obtains a beginning time of a countdown of the watchdog timer in response to a determination that the count value is equal to the initialization value;
the recording module further that obtains a stop time of the countdown and calculates an accuracy value of the watchdog timer according to the beginning time, the stop time and the initialization value; and
a determining module that determines if the accuracy value falls within the predetermined qualification range and displays the determination on a display device of the computer.

2. The computer of claim 1, wherein the accuracy value is calculated by: A=(T₂−T₁)/N, wherein A is the accuracy value, T₂ is the stop time of the countdown, T₁ is the beginning time of the countdown, and N is the initialization value.

3. The computer of claim 1, wherein a display module displays that the watchdog is qualified on the display device of the computer, in response to the determination that the accuracy value falls within the predetermined qualification range.

4. The computer of claim 1, wherein the display module displays that the watchdog is unqualified on the display device of the computer, in response to a determination that the accuracy value falls outside the predetermined qualification range.

5. A watchdog timer test method implemented by a computer, the computer in electronic communication with a motherboard, the method comprising:
(a) setting parameters for a test of a watchdog timer of a baseboard management controller (BMC) of the motherboard, wherein the parameters comprise a time duration of the watchdog timer, a predetermined qualification range of the watchdog timer;
(b) initializing the watchdog timer to convert the time duration into an initialization value, wherein the watchdog timer counts backward from the initialization value to zero;
(c) obtaining a count value from the watchdog timer;
(d) obtaining a beginning time of a countdown of the watchdog timer in response to a determination that the count value is equal to the initialization value;
(e) obtaining a stop time of the countdown and calculating an accuracy value of the watchdog timer according to the beginning time, the stop time and the initialization value; and
(f) determining if the accuracy value falls within the predetermined qualification range and displaying the determination on a display device of the computer.

6. The method of claim 5, wherein the accuracy value is calculated by: A=(T₂−T₁)/N, wherein A is the accuracy value, T₂ is the stop time of the countdown, 7′₁ is the beginning time of the countdown, and N is the initialization value.

7. The method of claim 5, wherein the watchdog timer is qualified, in response to a determination that the accuracy value falls within the predetermined qualification range.

8. The method of claim 5, wherein the watchdog timer is unqualified, in response to a determination that the accuracy value falls outside the predetermined qualification range.

9. A non-transitory computer-readable medium having stored thereon instructions that, when executed by a computer, the computer in electronic communication with a motherboard, causing the computer to perform a watchdog timer test method, the method comprising:
(a) setting parameters for a test of a watchdog timer of a baseboard management controller (BMC) of the motherboard, wherein the parameters comprise a time duration of the watchdog timer, a predetermined qualification range of the watchdog timer;
(b) initializing the watchdog timer to convert the time duration into an initialization value, wherein the watchdog timer counts backward from the initialization value to zero;
(c) obtaining a count value from the watchdog timer;
(d) obtaining a beginning time of a countdown of the watchdog timer in response to a determination that the count value is equal to the initialization value;
(e) obtaining a stop time of the countdown and calculating an accuracy value of the watchdog timer according to the beginning time, the stop time and the initialization value; and
(f) determining if the accuracy value falls within the predetermined qualification range and displaying the determination on a display device of the computer.

10. The non-transitory medium of claim 9, wherein the accuracy value is calculated by:
A=(T₂-T₁)/N, wherein A is the accuracy value, T₂ is the stop time of the countdown, T₁ is the beginning time of the countdown, and N is the initialization value.

11. The non-transitory medium of claim 9, wherein the watchdog timer is qualified, in response to a determination that the accuracy value falls within the predetermined qualification range.

12. The non-transitory method of claim 9, wherein the watchdog timer is unqualified, in response to a determination that the accuracy value falls outside the predetermined qualification range.
